(19) United States
(12) Patent Application Publication
(10) Pub. No.: US 2024/0104395 A1
(43) Pub. Date: Mar. 28, 2024

(54) MEMORY OPTIMIZATION METHOD AND DEVICE ORIENTED TO NEURAL NETWORK COMPUTING

(71) Applicant: ZHEJIANG LAB, Hangzhou (CN)

(72) Inventors: Hongsheng WANG, Hangzhou (CN); Guang CHEN, Hangzhou (CN)

(21) Appl. No.: 18/072,969

(22) Filed: Dec. 1, 2022

Related U.S. Application Data
(63) Continuation of application No. PCT/CN2022/124000, filed on Oct. 9, 2022.

(30) Foreign Application Priority Data
Sep. 27, 2022 (CN) 202211177786.5

(51) Int. Cl. G06N 3/10

(52) U.S. Cl. CPC G06N 3/10

(57) ABSTRACT

Disclosed are a memory optimization method and device oriented to neural network computing. The memory optimization method oriented to neural network computing includes the following steps: step S1: reconstructing a computation graph into a topological structure computation graph; step S2: constructing a life cycle interval about tensor variables; step S3: constructing a scanning line about the life cycle interval; step S4: allocating the tensor variables to idle registers; step S5: allocating to tensor variables exceeding the required number of registers; step S6: allocating registers allocated in the expired life cycle interval to tensor variables exceeding the required number of registers; and step S7: adding tensor variables transferred to a memory back to the life cycle interval in an activated state, and allocating idle registers for the tensor variables. According to the present disclosure, the memory of a data flow of a computation graph for neural network computing is optimized.

The present application claims priority to Chinese Patent Application No. 202211177786.5, submitted to the China National Intellectual Property Administration on Sep. 27, 2022 and entitled “MEMORY OPTIMIZATION METHOD AND DEVICE ORIENTED TO NEURAL NETWORK COMPUTING”, which is incorporated herein by reference in its entirety.

### TECHNICAL FIELD

The present disclosure relates to the technical field of a specific computing model-based computer system, and in particular to a memory optimization method and device oriented to neural network computing.

### BACKGROUND

With the increasing demand for large-scale neural network application in industrial complex scenarios, the memory space occupied by large neural network models (called as large model(s)) is increasing, the memory resources of an artificial intelligence hardware operating system cannot meet the requirement of large model training on the memory, so it is extremely important to optimize a neural network computing-oriented memory technology.

Therefore, provided are a memory optimization method oriented to neural network computing and a memory optimization device oriented to neural network computing.

### SUMMARY

An objective of the present disclosure is to provide a memory optimization method and device oriented to neural network computing, thereby solving the problems of how to optimize and reduce the persistent dependence and occupation on the memory resources of deep learning operating systems by tensor variables, reduce the memory overhead required by tensor variables in data flow and reduce requirements of large models on hardware memory resources.

The technical solution of the present disclosure is as follows:
a memory optimization method for oriented to neural network computing includes the following steps:
step S1: reconstructing a computation graph into a topological structure computation graph on a computer;
step S2: constructing a life cycle interval about tensor variables;
step S3: constructing a scanning line about the life cycle interval;
step S4: allocating the tensor variables to idle registers;
step S5: allocating registers corresponding to tensor variables in the life cycle interval at the furthest end point to tensor variables exceeding the required number of registers;
step S6: allocating registers allocated in the expired life cycle interval to tensor variables exceeding the required number of registers; and
step S7: adding tensor variables transferred to a memory back to the life cycle interval in an activated state, and allocating idle registers for the tensor variables.

Further, the step S1 specifically includes the following substeps:
step S11: traversing the computation graph in a postorder sequence to obtain a subgraph access list;
step S12: performing negative sequence operation on the postorder subgraph access list to obtain a topological structure sequence of the computation graph; and
step S13: reconstructing the computation graph according to the topological structure sequence to obtain a topological structure computation graph.

Further, the postorder sequence is that when a certain node of the computation graph is accessed, a successor node of the node is accessed preferentially and recursively.

Further, the step S2 is specifically as follows: constructing a life cycle interval about tensor variables included in each node, the life cycle interval corresponding to the tensor variables included in the node starting at the position of a first node in which the tensor variables are in a survival state and ending at the position of the last node in which the tensor variables are in a survival state.

Further, the step S3 is specifically as follows: constructing a scanning line parallel to the life cycle interval at the start node of the topological structure computation graph, the scanning line being used to observe whether idle registers are able to be allocated to tensor variables during data flow execution in the process of moving from a start end of the life cycle interval to a termination end of the life cycle interval.

Further, the step S5 is specifically as follows: when an execution flow is located at a certain node and the node has neither idle registers nor the life cycle interval that has been scanned and expired and is capable of being removed from the life cycle interval in an activated state, transferring the tensor variables in the registers allocated by the tensor variables corresponding to the life cycle interval at the furthest end point into a memory, and then allocating the released registers to the tensor variables exceeding the required number of the registers.

Further, the step S6 is specifically as follows: when an execution flow is located at a certain node and the scanning line has passed through the life cycle interval corresponding to the registers allocated by the tensor variables, removing the tensor variables from the life cycle interval in an activated state, recovering the correspondingly allocated registers into an idle register list, and allocating the idle registers to the tensor variables exceeding the required number of the registers.

Further, the step S7 is specifically as follows: when an execution flow is located at a certain node and idle registers are present, adding the tensor variables transferred into the memory back to the life cycle interval in an activated state, and allocating the idle registers to the corresponding life cycle interval.

The present disclosure further provides a memory optimization device oriented to neural network computing, including a memory and one or more processors, where executable codes are stored in the memory, and the one or more processors is used to implement the memory optimization method oriented to neural network computing according to any one of the above embodiments when executing the executable codes.

The present disclosure further provides a computer-readable storage medium, where the computer readable storage medium stores a program, and when the program is executed by a processor, the memory optimization method oriented to neural network computing according to any one of the above embodiments is implemented.

The present disclosure has the following beneficial effects: the present disclosure provides a mapping relationship between tensor variables generated in the computation graph executing process, and physical registers and a memory, and provides an optimization method based on the mapping relationship. The register may store the storage position of the tensor variables generated in the computation graph executing process in the memory. A conventional tensor variable storage method is to directly store the values of the tensor variables in the memory. As the values of the tensor variables may be stored in the memory or may be stored in the register, considering that the register allows a central processing unit to directly access and has the characteristic of high access speed, so according to the memory optimization method by virtue of the register provided by the present disclosure, the memory of a data flow of a computation graph provides for neural network computing is optimized, the memory overhead required by the tensor variables in the data flow is reduced, and requirements of the large models on hardware memory resources are reduced. According to the memory optimization method for neural network computing, the computing efficiency of the whole computation graph is improved, and hardware and time costs are saved.

### BRIEF DESCRIPTION OF FIGURES

FIG. 1 is a schematic flowchart of a memory optimization method oriented to neural network computing according to the present disclosure;

FIG. 2 is a schematic diagram of a process of reconstructing a computation graph into a topological structure according to Embodiment 1;

FIG. 3 is a topological structure computation graph according to Embodiment 1;

FIG. 4 illustrates constructing a life cycle interval about tensor variables included in a topological structure computation graph node according to Embodiment 1;

FIG. 5 illustrates allocating the previous two tensor variables included in a topological structure computation graph to two registers according to Embodiment 1;

FIG. 6 illustrates transferring tensor variables in registers into a memory and allocating new tensor variables to idle registers according to Embodiment 1;

FIG. 7 is a computation graph for neural network computing according to Embodiment 2;

FIG. 8 illustrates constructing a life cycle interval about tensor variables in data flow according to Embodiment 2;

FIG. 9 illustrates constructing a scanning line about a life cycle interval of tensor variables according to Embodiment 2;

FIG. 10 illustrates allocating a register r₃ to a variable x at a node V₁ according to Embodiment 2;

FIG. 11 illustrates allocating a register r₁ to a variable y at a node V₂ according to Embodiment 2;

FIG. 12 illustrates allocating a register r₂ to a variable z at a node V₃ according to Embodiment 2;

FIG. 13 illustrates allocating a register r₃ of a tensor variable x corresponding to a furthest end point interval Iₓ to a tensor variable b exceeding the required number of registers according to Embodiment 2;

FIG. 14 illustrates allocating a register r₁ allocated in the expired life cycle interval I_{y} to a tensor variable w exceeding the required number of registers according to Embodiment 2;

FIG. 15 illustrates removing a tensor variable corresponding to the expired life cycle interval from a life cycle interval list in an activated state and recovering a register according to Embodiment 2;

FIG. 16 illustrates removing a tensor variable corresponding to the expired life cycle interval from a life cycle interval list in an activated state and recovering a register according to Embodiment 2;

FIG. 17 illustrates allocating an idle register r₃ to a life cycle interval corresponding to Iᵣ₃ according to Embodiment 2; and

FIG. 18 is a schematic diagram of a memory optimization device oriented to neural network computing according to Embodiment 3.

### DETAILED DESCRIPTION

The following description of the at least one exemplary embodiment is actually merely illustrative and never constitutes any limitation to the present disclosure and application or use thereof. All other embodiments obtained by a person of ordinary skill in the art based on the embodiments of the present disclosure without creative efforts shall fall within the protection scope of the present disclosure.

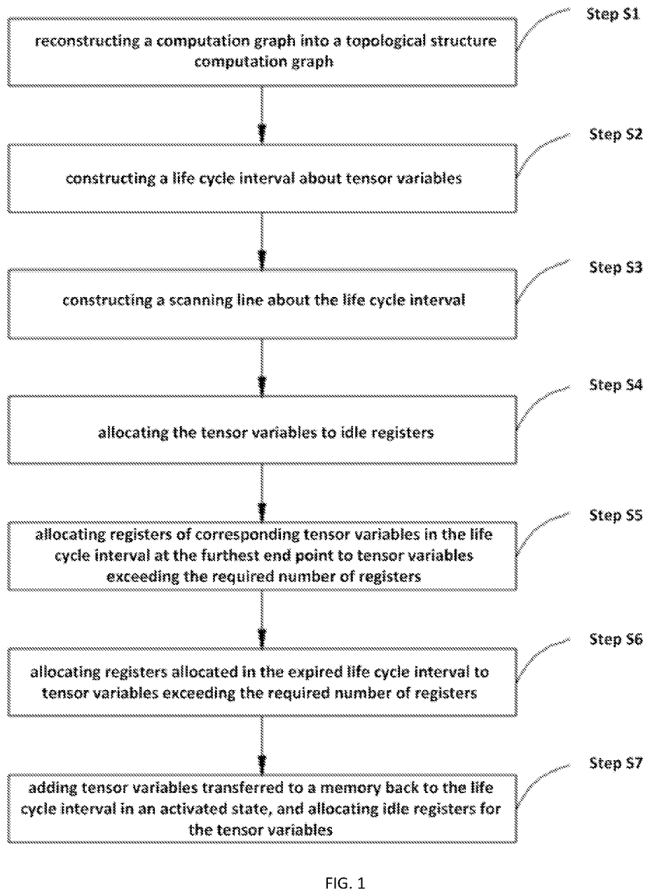

Referring to FIG. 1, a memory optimization method oriented to neural network computing includes the following steps:
step S1: a computation graph is reconstructed into a topological structure computation graph.
Step S11: the computation graph is traversed in a postorder sequence to obtain a subgraph access list,
where the postorder sequence is that when a certain node of the computation graph is accessed, a successor node of the node is accessed preferentially and recursively.
Step S12: the postorder subgraph access list is subjected to negative sequence operation to obtain a topological structure sequence of the computation graph.
Step S13: the computation graph is reconstructed according to the topological structure sequence to obtain a topological structure computation graph.
Step S2: a life cycle interval about tensor variables is constructed, which is specifically as follows:
a life cycle interval about tensor variables included in each node is constructed, the life cycle interval corresponding to the tensor variables included in the node starting at the position of a first node in which the tensor variables are in a survival state and ending at the position of the last node in which the tensor variables are in a survival state.
Step S3: a scanning line about the life cycle interval is constructed, which is specifically as follows:
a scanning line parallel to the life cycle interval at the start node is constructed at the start node of the topological structure computation graph, the scanning line being used to observe whether idle registers are able to be allocated to tensor variables during data flow execution in the process of moving from a start end of the life cycle interval to a termination end of the life cycle interval.
Step S4: the tensor variables are allocated to idle registers.
Step S5: registers of corresponding tensor variables in the life cycle interval at the furthest end point are allocated to tensor variables exceeding the required number of registers, which is as follows:
when an execution flow is located at a certain node and the node has neither idle registers nor the life cycle interval that has been scanned and expired and can be removed from the life cycle interval in an activated state, the tensor variables in the registers allocated by the tensor variables corresponding to the life cycle interval at the furthest end point are transferred into a memory, and then the released registers are allocated to the tensor variables exceeding the required number of the registers.
Step S6: registers allocated in the expired life cycle interval are allocated to tensor variables exceeding the required number of registers, which is as follows:
when an execution flow is located at a certain node and the scanning line has passed through the life cycle interval corresponding to the registers allocated by the tensor variables, the tensor variables are removed from the life cycle interval in an activated state, the correspondingly allocated registers are recovered into an idle register list, and the idle registers are allocated to the tensor variables exceeding the required number of the registers.
Step S7: tensor variables transferred to the memory are added back to the life cycle interval in an activated state, and idle registers are allocated for the tensor variables, which is as follows:
when an execution flow is located at a certain node and idle registers are present, the tensor variables transferred into the memory are added back to the life cycle interval in an activated state, and the idle registers are allocated to the corresponding life cycle interval.

Functions of the corresponding accompanying drawings in the following embodiments are defined as follows:
tf.random_uniform([[5,3]]) means: randomly generating a tensor with a shape of 5 rows and 3 columns.

goto Vᵢ means: going to execute the computational flow of the node Vᵢ.

If the expression goto Vᵢ means: determining whether the value of the expression is true, executing the computational flow of the node Vᵢ if the value of the expression is true, otherwise, executing the computation flow of other branch nodes.

tf.add(x,y) means: performing an adding operation on a tensor x and a tensor y.

tf.ones(aᵢ.shape) means: creating a tensor of which the shape is as same as the shape of the tensor aᵢ and all elements are 1.

Ø(aᵢ,aⱼ) means a routing selector of the correct definition of a tensor variable aᵢ and a tensor variable aⱼ about a tensor variable a.

tf.relu(x) means: inputting a tensor x into a rectified linear unit.

tf.matmul(x,y) means: performing a matrix multiplication operation on a tensor x and a tensor y.

return bᵢ means: returning to execute a branch including a tensor variable bᵢ.

Iₓ means a life cycle interval of a tensor variable x.
tf.subtract(x,y) means: performing a subtraction operation on a tensor x and a tensor y.

rᵢ means: allocating an idle register rᵢ to a tensor variable of the corresponding life cycle interval.

Srᵢ means a storage operation, storing a tensor variable a₀ in a register rᵢ into a memory.

Iᵣ_{ᵢ} means a storage operation, loading a tensor variable a₀ in a memory into a register rᵢ.

### Embodiment 1

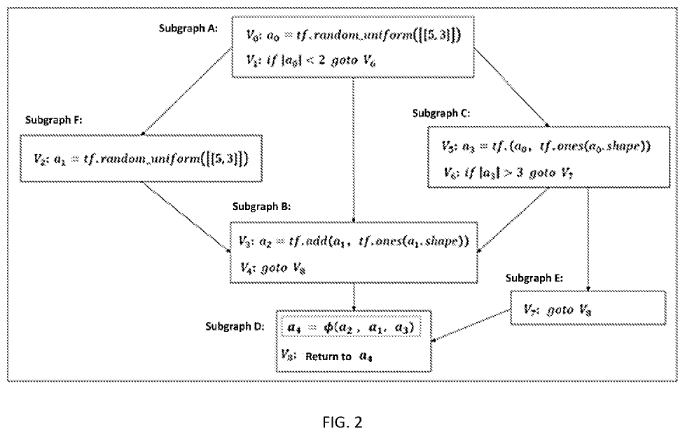

Referring to FIG. 2, step S1: a computation graph is reconstructed into a topological structure computation graph.
Step S11: the computation graph is traversed in a postorder sequence to obtain a subgraph access list,
the computation graph is traversed in a postorder sequence to obtain a subgraph access list: D, B, E, C, F and A; and
the postorder sequence is that when a certain node of the computation graph is accessed, a successor node of the node is accessed preferentially and recursively.

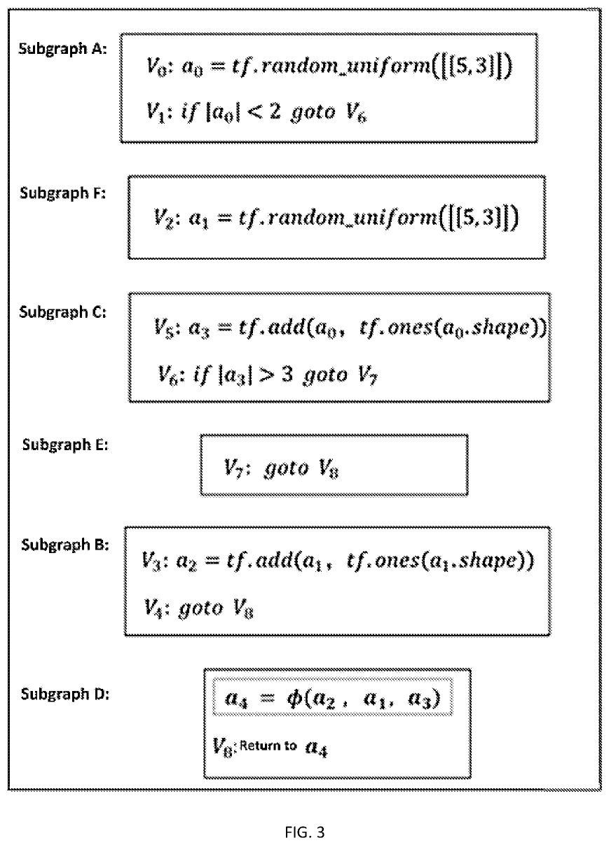

When a certain node C in the computation graph is accessed according to the postorder sequence, all connected edges of the node V_{C} have been accessed. The traversal according to the postorder sequence may ensure that the node V_{B} must be accessed prior to the node V_{A} in a route from a node V_{A} to a node V_{B} during computation graph traversal.
Step S12: the postorder subgraph access list is subjected to negative sequence operation to obtain a topological structure sequence of the computation graph,
the postorder subgraph access list is subjected to a negative sequence operation to obtain a topological structure sequence of the computation graph: A, F, C, E, B and D; and
the negative sequence operation of the postorder node list refers to: the list of nodes obtained through access according to the first-step postorder sequence is subjected to a negative sequence operation. The negative sequence operation of the postorder node list ensures that if a route from a node V_{A} to a node V_{B} is present in the figure, the node V_{A} in the obtained topological sequence list appears prior to the node V_{B}. The negative-sequence postorder process ensures that it is necessary to preferentially access the node V_{C} before the computation graph with the topological structure accesses any other nodes connected to a certain node V_{C}.
Step S13: the computation graph is reconstructed according to the topological structure sequence to obtain a topological structure computation graph, referring to FIG. 3.

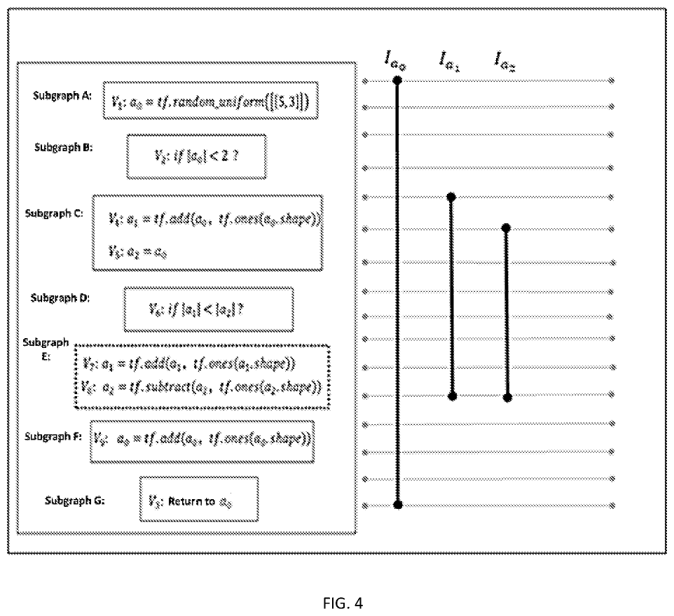

Referring to FIG. 4, the step S2: a life cycle interval about tensor variables is constructed, which is specifically as follows:
a life cycle interval about tensor variables included in each node is constructed, the life cycle interval corresponding to the tensor variables included in the node starts at the position of a first node in which the tensor variables are in a survival state and ends at the position of the last node in which the tensor variable is in a survival state.

For the tensor variable v included in the node, the life cycle interval Iᵥ corresponding to the tensor variable starts at the position of a first node in which the tensor variable v is in a survival state and ends at the position of the last node in which the tensor variable v is in a survival state.
Step 1: a life cycle interval Iₐ_{₀} about a tensor variable a₀ is constructed, where the life cycle interval Iₐ_{₀} of the tensor variable a₀ starts at the node V₁ and ends at the node V₃.
Step 2: a life cycle interval Iₐ_{₁} about a tensor variable a₁ is constructed, where the life cycle interval Iₐ_{₁} about the tensor variable a₁ starts at the node V₄. A connected edge from a subgraph E to a subgraph D is present between the subgraph E and the subgraph D, so the tensor variable a₁ will pass through the node V₈ to arrive at the subgraph D, and the life cycle interval Iₐ_{₁} about the tensor variable a₁ ends at the node V₈.
Step 3: a life cycle interval Iₐ_{₂} about a tensor variable a₂ is constructed. The life cycle interval Iₐ_{₂} about the tensor variable a₂ starts at the node V₅. A connected edge from a subgraph E to a subgraph D is present between the subgraph E and the subgraph D, so the tensor variable a₂ will pass through the node V₈ to arrive at the subgraph D, and the life cycle interval Iₐ_{₂} about the tensor variable a₂ ends at the node V₈.
Step S3: a scanning line about the life cycle interval is constructed.

A scanning line parallel to the life cycle interval is constructed at the start node of the topological structure computation graph, the scanning line is used to observe whether idle registers are able to be allocated to tensor variables during data flow execution in the process of moving from the start end of the life cycle interval to the termination end of the life cycle interval.

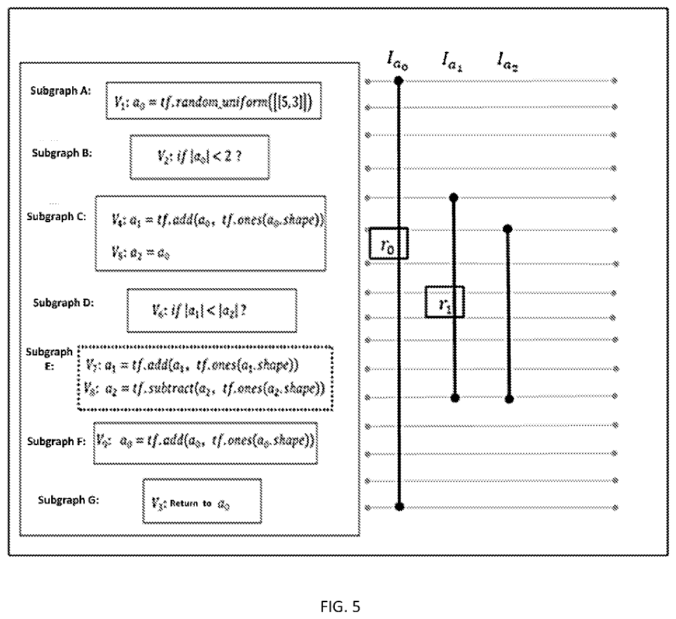

Referring to FIG. 5, the step S4: the tensor variables are allocated to idle registers.

Allocating the tensor variables included in the topological structure computation graph node to two registers r₀ and r₁ includes the following processes:
step 1: the tensor variable a₀ is allocated to the idle register r₀; and
step 2: the tensor variable a₁ is allocated to the idle register r₁.
Step S5: registers of corresponding tensor variables in the life cycle interval at the furthest end point are allocated to tensor variables exceeding the required number of registers, which is as follows:
when an execution flow is located at a certain node Vᵢ and the node has neither idle registers nor the life cycle interval that has been scanned and expired and can be removed from the life cycle interval in an activated state, the tensor variable i in the register rᵢ allocated by the tensor variable i corresponding to the life cycle interval at the furthest end point is transferred into a memory, and then the released register rᵢ is allocated to the tensor variable j exceeding the required number of the registers,
Step S6: registers allocated in the expired life cycle interval Iᵢ are allocated to the tensor variable j exceeding the required number of registers, which is as follows:
when an execution flow is located at a certain node Vᵢ and the scanning line has passed through the life cycle interval Iᵢ corresponding to the register rᵢ allocated by the tensor variable i, the tensor variable i is removed from the life cycle interval in an activated state, the correspondingly allocated register rᵢ is recovered into an idle register list, and the idle register rᵢ is allocated to the tensor variable j exceeding the required number of the registers.

Referring to FIG. 6, step S7: tensor variables transferred to the memory are added back to the life cycle interval in an activated state, and idle registers are allocated for the tensor variables, which is as follows:
when an execution flow is located at a certain node Vᵢ and an idle register rᵢ is present, the tensor variable i transferred into the memory is added back to the life cycle interval in an activated state, and the idle register rᵢ is allocated to the corresponding life cycle interval Iᵢ.

When a data flow flows through a redefined node including the tensor variable i, it is necessary to store the tensor variable i of the register rᵢ into the memory; and when the data flow flows through a using node including the tensor variable i, it is necessary to load the tensor variable i from the memory to the register rᵢ. The process Iᵣ_{₀} of adding the tensor variable transferred into the memory back to the interval list in the activated state marks the indicated position.

In the first step, since both the nodes V₁ and V₉ include the definition of the tensor variable a₀, it is necessary to store the tensor variable a₀ in the register r₀ at the nodes Vᵢ and V₉ into the memory. As show in FIG. 6, marks the indicated position.

In the second step, since all the nodes V₂, V₄, V₅, V₉ and V₃ include the use of the tensor variable a₀, it is necessary to load the tensor variable a₀ at the node from the memory to the register r₀.

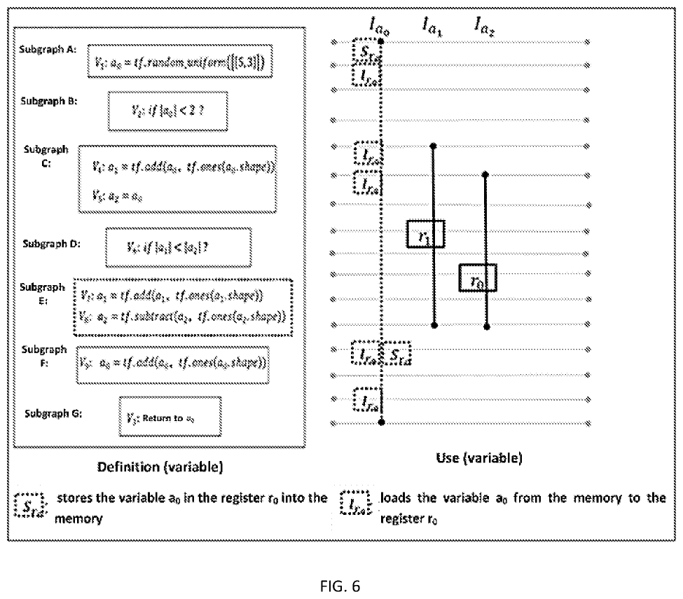

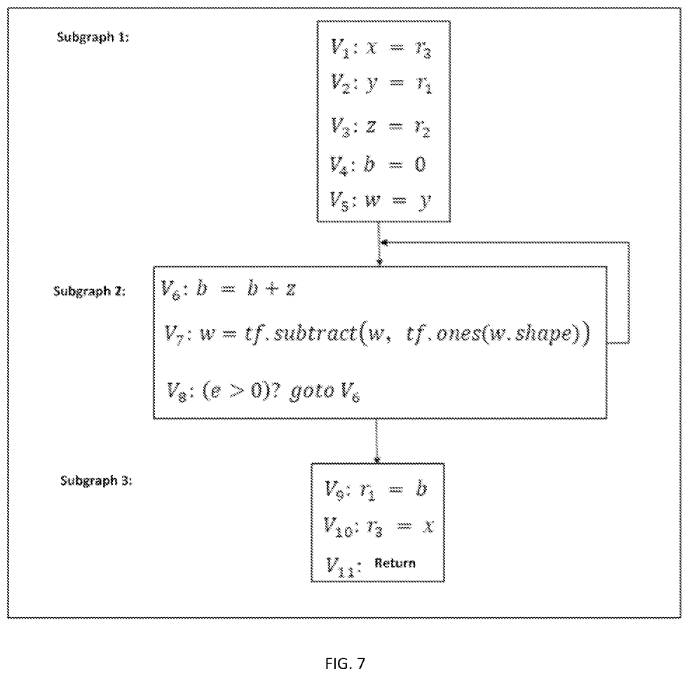

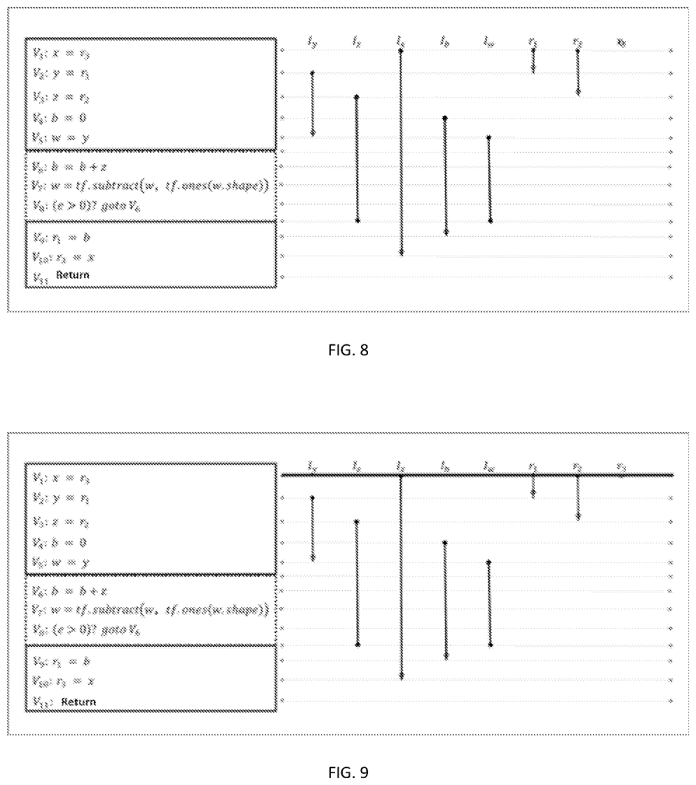

Referring to FIG. 7, in Embodiment 2, according to a memory optimization method oriented to neural network computing, three registers are allocated for tensor variables in a computation graph execution flow for neural network computing in the memory optimization process, specifically as follows:
step S1: a computation graph is reconstructed into a topological structure computation graph, as shown in the computation graph shown in the left of FIG. 8.
Step S2: a life cycle interval about sensor variables is constructed, as the computation graph shown in the right of FIG. 8.
Step S3: a scanning line about the life cycle interval is constructed.

A scanning line parallel to a start line of the life cycle interval is constructed at a start node V₁ of the topological structure computation graph. The scanning line is used to assist in observing the states of the idle registers and the tensor variables. The working mode of the scanning line is to observe whether an idle register may be allocated to the tensor variable during data flow execution in the process of moving from the start end of the life cycle interval to the termination end of the life cycle interval. Referring to FIG. 9, the top transverse line represents the scanning line.
Step S4: the tensor variables are allocated to idle registers.

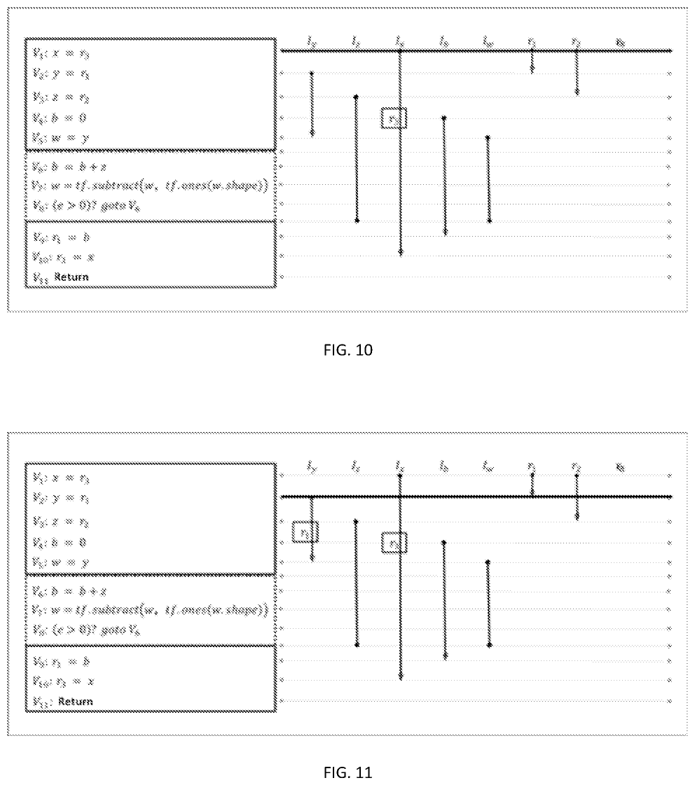

Referring to FIG. 10, the idle register r₃ is allocated to the tensor variable x. At the start position of the scanning line, that is, the node Vᵢ, it is found that the idle register r₃ may be allocated to the tensor variable x.

Referring to FIG. 11, the register r₁ is allocated to the tensor variable y at the node V₂. When the scanning line scans the position of the node V₂, it is found that the scanning line has passed through the life cycle interval of the register r₁, so the life cycle interval of the register r₁ may be removed from the life cycle interval list in the activated state, and the register r₁ is recovered into the idle register list. Finally, the idle register r₁ may be allocated to the tensor variable y.

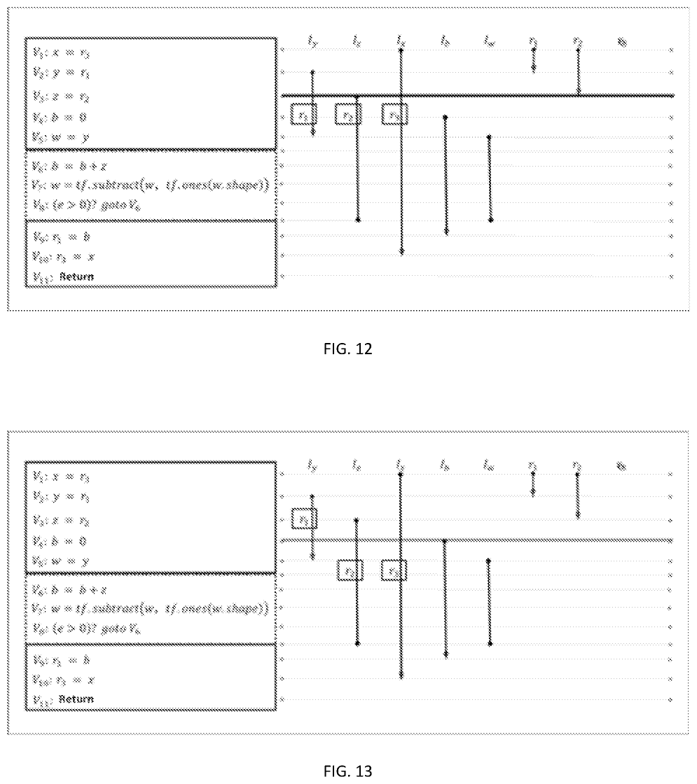

Referring to FIG. 12, the register r₂ is allocated to the tensor variable z at the node V₃. When the scanning line scans the node V₃, it is found that the scanning line has passed through the life cycle interval of the register r₂, so the life cycle interval of the register r₂ may be removed from the life cycle interval list in the activated state, and the register r₂ is recovered into the idle register list. Finally, the idle register r₂ may be allocated to the tensor variable z.
Step S5: registers of corresponding tensor variables in the life cycle interval at the furthest end point are allocated to tensor variables exceeding the required number of registers.

Referring to FIG. 13, when the scanning line scans the position of the node V₄, it is found that there are neither idle registers nor the life cycle interval that has been scanned and expired and may be removed from the life cycle interval list in the activated state. Therefore, it is necessary to transfer the tensor variable in the register r₃ allocated by the tensor variable x corresponding to the life cycle interval at the furthest end point into the memory, and then allocate the released register r₃ to the tensor variable b exceeding the required number of the registers. The tensor variable x is stored in the memory, so the life cycle interval corresponding to the tensor variable x is updated to a dotted line.

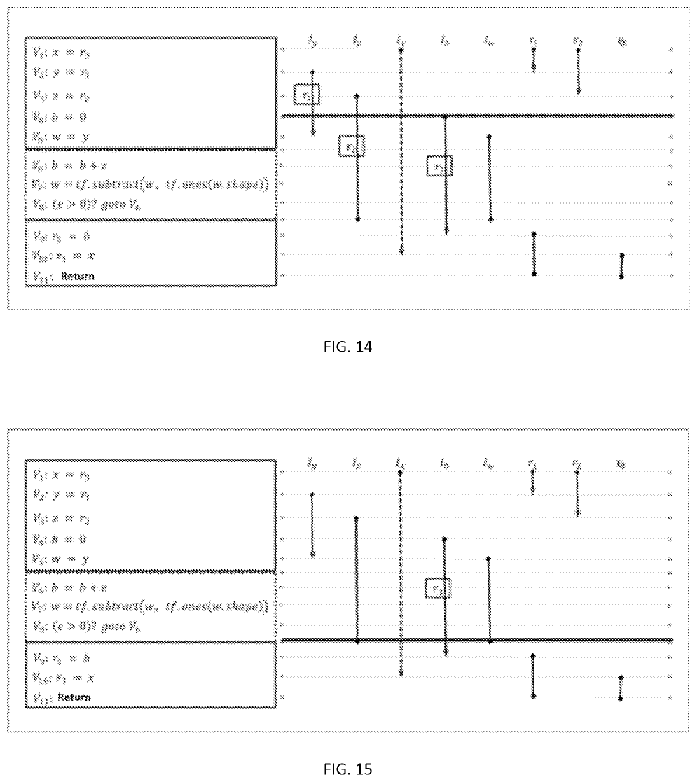

Referring to FIG. 14, the register allocated by the expired life cycle interval I_{y} is allocated to the tensor variable w exceeding the required number of the registers. When the scanning line scans the position of the node V₅, it is found that the scanning line has passed through the life cycle interval I_{y} corresponding to the register r₁ allocated by the tensor variable y, so the tensor variable y may be removed from the life cycle interval list in the activated state, and the register r₁ is recovered into the idle register list. Finally, the idle register r₁ may be allocated to the tensor variable w exceeding the required number of the registers.
Step S6: registers allocated in the expired life cycle interval are allocated to tensor variables exceeding the required number of registers.

Referring to FIG. 15, the register allocated in the expired life cycle interval is recovered into the idle register list. When the scanning line scans the ending position of the node V₈, it is found that the scanning line has passed through the life cycle interval I_{z} corresponding to the register r₂ allocated by the tensor variable z and the life cycle interval I_{w} corresponding to the register r₁ allocated by the tensor variable w. Therefore, the tensor variables z and w corresponding to the expired life cycle intervals I_{z} and I_{w} are removed from the life cycle interval list in the activated state, and the registers r₂ and r₁ are recovered into the idle register list.

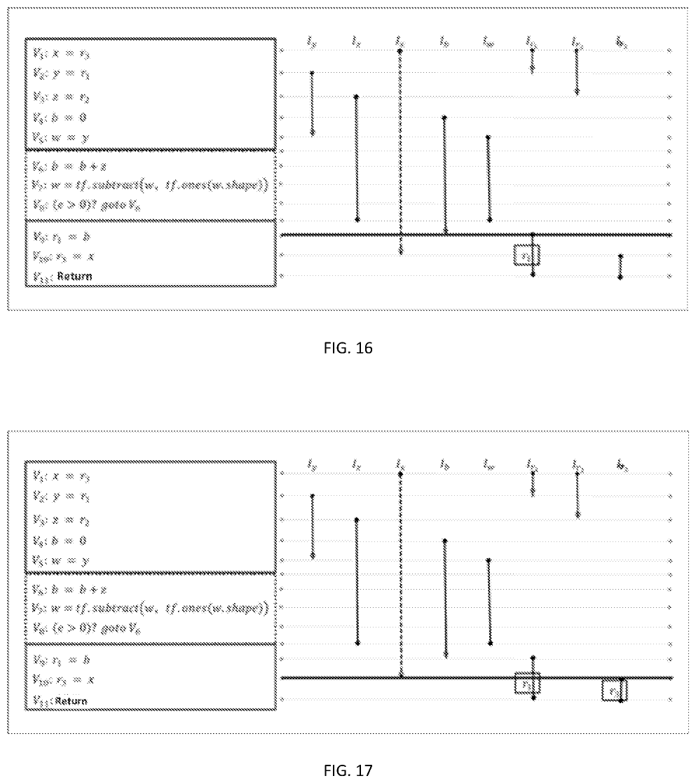

Referring to FIG. 16, the register allocated in the expired life cycle interval is recovered into an idle register pool, and the idle register is allocated to the life cycle interval in the activated state. When the scanning line scans the position of the node V₉, it is found that the scanning line has passed through the life cycle interval I_{b} corresponding to the register r₃ allocated by the tensor variable b. Therefore, the tensor variable b corresponding to the expired life cycle interval I_{b} is removed from the life cycle interval list in the activated state, and the register r₃ is recovered into the idle register list. When the scanning line scans the position of the node V₉, it is found that an idle register r₁ is present, and the idle register r₁ is allocated to the life cycle interval corresponding to Iᵣ_{₁}. When the scanning line scans the position of the node V₁₀, it is found that an idle register r₃ is present, and the idle register r₃ is allocated to the life cycle interval corresponding to Iᵣ_{₃}.
Step S7: tensor variables transferred to the memory are added back to the life cycle interval in an activated state, and idle registers are allocated for the tensor variables.

Referring to FIG. 17, when the scanning line scans the position of the node V₁₀, it is found that an idle register r₂ is present, the variable x transferred into the memory is added back to the life cycle interval list in the activated state, and the idle register r₂ is allocated to the life cycle interval corresponding to Iₓ.

The method as stated above provides a mapping relationship between tensor variables generated in the computation graph executing process, and physical registers and a memory, and provides an optimizing method based on the mapping relationship. The register may store the storage position of the tensor variables generated in the computation graph executing process in the memory. A conventional tensor variable storage method is to directly store the values of the tensor variables in the memory. As the values of the tensor variables may be stored in the memory or may be stored in the register, considering that the register allows a central processing unit to directly access and has the characteristic of high access speed, so according to the method for optimizing the memory by virtue of the register provided by the present disclosure, the memory of a data flow of a computation graph provides for neural network computing is optimized, the memory overhead required by the tensor variables in the data flow is reduced, and requirements of the large models on hardware memory resources are reduced. According to the memory optimizing method for neural network computing, the computing efficiency of the whole computation graph is improved, and hardware and time costs are saved.

Corresponding to the above embodiment of the memory optimization method oriented to neural network computing, the present disclosure further provides Embodiment 3 of a memory optimization device oriented to neural network computation.

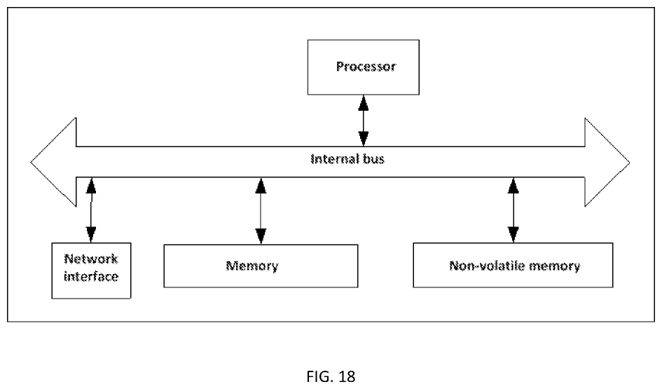

Referring to FIG. 18, Embodiment 3 of the present disclosure provides a memory optimization device oriented to neural network computing, including a memory and one or more processors, executable codes are stored in the memory, and the one or more processors is used to implement the memory optimization method oriented to neural network computing according to any one of the above embodiments when executing the executable codes.

Embodiment 3 of the memory optimization device oriented to neural network computing according to the present disclosure may be applied to any equipment with data processing ability, and the any equipment with data processing ability may be equipment or a device such as a computer. The device of Embodiment 3 may be implemented through software, or may be implemented through hardware or a combination of hardware and software. Taking software implementation as an example, a device in a logical sense is formed as follows: a processor of the any equipment with data processing ability reads a corresponding computer program instruction in a non-volatile memory into a memory for operation. From the aspect of the hardware layer, as shown in FIG. 18 which is a hardware structure diagram of any equipment with data processing ability where a memory optimization device oriented neural network computing is, in addition to a processor, a memory, a network interface and a non-volatile memory shown in FIG. 18, any equipment with data processing ability where the memory optimization device oriented to neural network computing in Embodiment 3 is may further include other hardware generally according to any equipment with data processing ability, which will not be elaborated here.

The details of the implementation process of the function and action of each unit in the above device are referenced to the implementation process of the corresponding steps in the above method, which will not elaborated here.

With regard to the device embodiment 3, since it substantially corresponds to the method embodiment, relevant parts may refer to the parts of the method embodiment. The device embodiment 3 described above is merely illustrative. The units described above as separate components may or may not be physically separated, and the components displayed as units may or may not be physical units, that is, they may be located in one place, or may be distributed to a plurality of network units. Some or all of the modules may be selected according to actual needs to achieve the objectives of the solutions of the present disclosure. Those of ordinary skill in the art can understand and implement without any creative effort.

The embodiment of the present disclosure further provides a computer-readable storage medium, where the computer readable storage medium stores a program, and when the program is executed by the processor, the memory optimization method oriented to neural network computing according to the above embodiments is implemented.

The computer-readable storage medium may be an internal storage unit of any equipment with data processing ability according to any one of the above embodiments, such as a hard disk or a memory. The computer-readable storage medium may further be external storage equipment of any equipment with data processing ability, for example, a plug type hard disk, a smart media card (SMC), an SD card and a flash card that are arranged on the equipment. Further, the computer-readable storage medium may further include an internal storage unit and external storage equipment of any equipment with data processing ability. The computer-readable storage medium is used to store the computer programs, and other programs and data required by any equipment with data processing ability, and may further be used to temporarily store data that has been or will be output.

The above is merely illustrative of the preferred embodiments of the present disclosure and is not intended to limit the present disclosure, and various modifications and changes may be made by those skilled in the art. Any modifications, equivalent substitutions, improvements and the like made within the spirit and scope of the present disclosure should be included within the protection scope of the present disclosure.

1. A memory optimization method oriented to neural network computing, comprising the following steps:
step S1: reconstructing a computation graph into a topological structure computation graph on a computer;
step S2: constructing a life cycle interval about tensor variables, wherein the life cycle interval starts at a first node in which the tensor variables are in a survival state and ends at a last node in which the tensor variables are in the survival state;
step S3: constructing a scanning line about the life cycle interval;
step S4: allocating the tensor variables to idle registers;
step S5: allocating registers corresponding to tensor variables that are in the survival state at an end of the life cycle interval to tensor variables exceeding a required number of registers;
step S6: allocating registers allocated in an expired life cycle interval to the tensor variables exceeding the required number of registers; and
step S7: adding tensor variables transferred to a memory back to the life cycle interval in an activated state, and allocating idle registers for the tensor variables.

2. The memory optimization method oriented to neural network computing according to claim 1, wherein the step S1 specifically comprises the following substeps:
step S11: traversing the computation graph in a postorder sequence to obtain a subgraph access list;
step S12: performing negative sequence operation on the postorder subgraph access list to obtain a topological structure sequence of the computation graph; and
step S13: reconstructing the computation graph according to the topological structure sequence to obtain a topological structure computation graph.

3. The memory optimization method oriented to neural network computing according to claim 2, wherein the postorder sequence is that when a certain node of the computation graph is accessed, a successor node of the node is accessed preferentially and recursively.

4. The memory optimization method oriented to neural network computing according to claim 1, wherein the step S2 is specifically as follows: constructing a life cycle interval about tensor variables comprised in each node, the life cycle interval corresponding to the tensor variables comprised in the node starting at the position of a first node in which the tensor variables are in a survival state and ending at the position of the last node in which the tensor variables are in a survival state.

5. (canceled)

6. The memory optimization method oriented to neural network computing according to claim 1, wherein the step S5 is specifically as follows: when an execution flow is located at a certain node and the node has neither idle registers nor a life cycle interval that has been scanned and expired and is capable of being removed from the life cycle interval in an activated state, transferring the tensor variables in the registers allocated by the tensor variables that are in the survival state at the end of the life cycle interval into a memory, and then allocating the released registers to the tensor variables exceeding the required number of registers.

7. The memory optimization method oriented to neural network computing according to claim 1, wherein the step S6 is specifically as follows: when an execution flow is located at a certain node and the scanning line has passed through the life cycle interval corresponding to the registers allocated by the tensor variables, removing the tensor variables from the life cycle interval in an activated state, recovering the correspondingly allocated registers into an idle register list, and allocating the idle registers to the tensor variables exceeding the required number of registers.

8. The memory optimization method oriented to neural network computing according to claim 1, wherein the step S7 is specifically as follows: when an execution flow is located at a certain node and idle registers are present, adding the tensor variables transferred into the memory back to the life cycle interval in an activated state, and allocating the idle registers to the corresponding life cycle interval.

9. A memory optimization device oriented to neural network computing, comprising a non-transitory memory and one or more processors, wherein executable codes are stored in the non-transitory memory, and the one or more processors is used to implement the memory optimization method oriented to neural network computing according to claim 1 when executing the executable codes.

10. A non-transitory computer-readable storage medium, wherein the computer readable storage medium stores a program, and when the program is executed by a processor, the memory optimization method oriented to neural network computing according to claim 1 is implemented.
